(19) United States
(12) Patent Application Publication
(10) Pub. No.: US 2026/0031726 A1
(43) Pub. Date: Jan. 29, 2026

(54) SEMICONDUCTOR DEVICE, SWITCHING POWER SUPPLY DEVICE, COMPOSITE POWER SUPPLY DEVICE, AND LINEAR IC

(71) Applicant: ROHM Co., LTD., Kyoto (JP)

(72) Inventor: Kiminobu SATO, Kyoto (JP)

(21) Appl. No.: 19/270,729

(22) Filed: Jul. 16, 2025

(30) Foreign Application Priority Data
Jul. 25, 2024 (JP) 2024-120260

(51) Int. Cl. H02M 3/158; H02M 3/07

(52) U.S. Cl. CPC H02M 3/158; H02M 3/07

(57) ABSTRACT

Provided is a semiconductor device including a common terminal connected to an external capacitor outside of the semiconductor device, a function selection unit configured to execute a selection operation for outputting a selection signal for selecting a designated function according to an amount of charge accumulated in the external capacitor, and an internal power supply unit configured to supply a voltage to an internal circuit provided inside the semiconductor device, in which the external capacitor is electrically connected to the function selection unit when the selection operation is performed, and the external capacitor is electrically connected to the internal power supply unit and the internal circuit when a supply operation for supplying a supply voltage from the internal power supply unit to the internal circuit is performed.

### CROSS REFERENCE TO RELATED APPLICATIONS

This application claims priority benefit of Japanese Patent Application No. JP 2024-120260 filed in the Japan Patent Office on Jul. 25, 2024. Each of the above-referenced applications is hereby incorporated herein by reference in its entirety.

### BACKGROUND

The present disclosure pertains to a semiconductor device, a switching power supply device, a composite power supply device, and a linear integrated circuit (IC).

A semiconductor device has a determination circuit that makes a determination on the basis of the impedance of an element that is connected to the outside thereof. In addition, separately from the element used in the determination circuit, the semiconductor device is provided with a capacitor if supplied with a voltage from an internal power supply unit (for example, refer to domestic re-publication of PCT international publication for patent application No. 2018/030230).

### BRIEF DESCRIPTION OF THE DRAWINGS

FIG. 1 is a schematic circuit diagram of a semiconductor device;

FIG. 2 is a timing chart that indicates the state of each signal when the semiconductor device is operating;

FIG. 3 is a schematic circuit diagram of a semiconductor device according to a second embodiment;

FIG. 4 is a schematic circuit diagram that illustrates an exemplary configuration of a switching power supply device that uses the semiconductor device; and

FIG. 5 is a schematic circuit diagram that illustrates an exemplary configuration of a composite power supply device that uses the semiconductor device.

### DETAILED DESCRIPTION

With reference to the drawings, examples of embodiments of the present disclosure are described in detail below. In the drawings referenced, the same reference symbols are given to the same portions, and the duplicative description pertaining to the same portions is omitted in principle. Note that, in the present specification, characters or reference symbols for referring to information, signals, physical quantities, functional units, circuits, elements, components, or other portions may be used to omit or abbreviate the names of the information, the signals, the physical quantities, the functional units, the circuits, the elements, the components, or other portions corresponding to the characters or reference symbols, for the simplification of the description.

In addition, a “connection” between a plurality of portions that form any circuit element, wiring, or circuit includes a case of being mechanically connected as well as a case of being electrically connected, in other words, a state where electricity flows. In other words, “connecting” includes the case of “electrically connecting.”

A switch is in an on-state or an off-state. When a switch is in the on-state, an electrical connection is made between both ends of the switch. In contrast, when a switch is in the off-state, there is no electrical connection between both ends of the switch. In addition, the on-state and the off-state can be simply represented as on and off, respectively, in the following description.

There are cases where a metal-oxide semiconductor (MOS) field-effect transistor is used as an example of a switching element. A MOS field-effect transistor refers to a transistor that has the gate structure including at least three layers: a “layer that includes an electrical conductor or a semiconductor such as polysilicon having a low resistance value,” an “insulating layer,” and a “P-channel, N-channel, or intrinsic semiconductor layer.” In other words, the gate structure of a MOS field-effect transistor is not limited to a three-layer structure of metal, oxide, and a semiconductor.

### First Embodiment

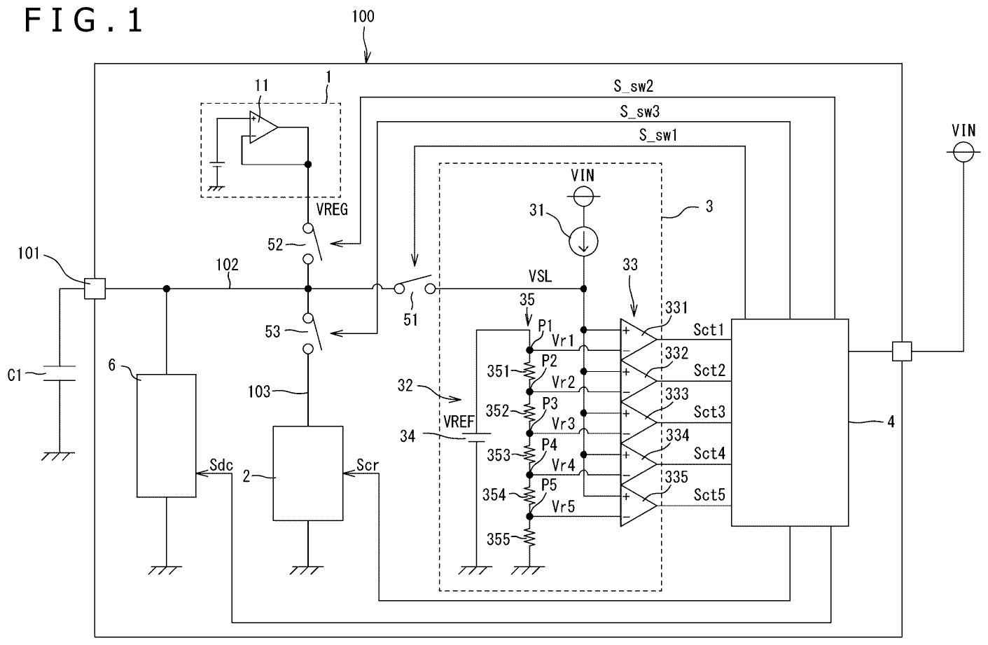

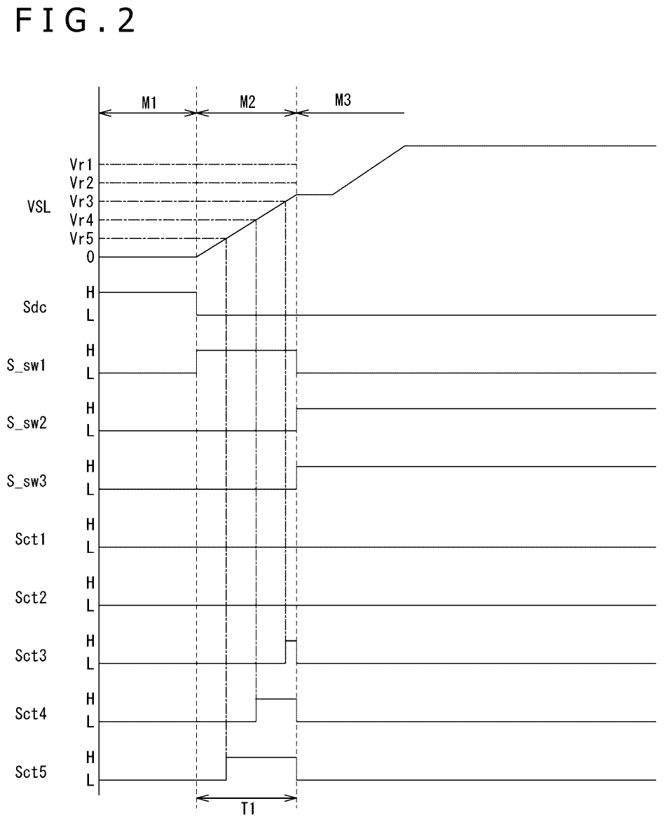

A description is given for a first embodiment of the present disclosure. FIG. 1 is a schematic circuit diagram of a semiconductor device 100. FIG. 2 is a timing chart that indicates the state of each signal when the semiconductor device 100 is operating. For example, the semiconductor device 100 is used as a control device for controlling a power supply device that is mounted in a vehicle or other machines. The semiconductor device 100 can execute a function that is selected from among a plurality of functions. The semiconductor device 100 has an internal power supply unit 1, an internal circuit 2, a function selection unit 3, and a control unit 4.

As illustrated in FIG. 1, the semiconductor device 100 also has a common terminal 101, a common wire 102, an internal circuit connection wire 103, a first switch 51, a second switch 52, and a third switch 53. In the semiconductor device 100, the common wire 102 is connected to the common terminal 101. As illustrated in FIG. 1, an external capacitor C1 is provided outside of the semiconductor device 100 and connected to the common terminal 101. A first end of the external capacitor C1 is connected to the common terminal 101, and a second end of the external capacitor C1 is connected to ground. The external capacitor C1 is what is called an output capacitor and is provided in order to stabilize a supply voltage VREG.

The semiconductor device 100 may be a functional IC in which the internal power supply unit 1, the internal circuit 2, the function selection unit 3, and the control unit 4 are integrated in one package. The common terminal 101, the common wire 102, the internal circuit connection wire 103, the first switch 51, the second switch 52, and the third switch 53 are arranged inside the package for the functional IC.

### Internal Circuit 2

The internal circuit 2 is a circuit included in the semiconductor device 100, such as a driver circuit for driving a power supply device, a timer circuit, or a clock circuit, for example. As illustrated in FIG. 1, the supply voltage VREG is supplied to the internal circuit 2 from the internal power supply unit 1. Note that the function selection unit 3 and the control unit 4 are driven by an input voltage VIN that is supplied from outside of the semiconductor device 100. The internal circuit 2 is connected to the internal circuit connection wire 103. The internal circuit connection wire 103 is connected to the common wire 102 via the third switch 53.

### Internal Power Supply Unit 1

The internal power supply unit 1 has, for example, a configuration using an operational amplifier 11, in which a voltage is supplied to a non-inverting input terminal of the operational amplifier 11, and an output terminal and an inverting input terminal thereof are short-circuited. In addition, the output terminal of the operational amplifier 11 is connected to the second switch 52. From the internal power supply unit 1, the supply voltage VREG, which is a stabilized voltage, is supplied to the internal circuit 2. The internal power supply unit 1 is connected to the common wire 102 via the second switch 52.

### Function Selection Unit 3

The function selection unit 3 has a current source 31, a reference voltage output unit 32, and a comparing unit 33. The function selection unit 3 is connected to the common wire 102 via the first switch 51. More specifically, the current source 31 and the comparing unit 33 of the function selection unit 3 are connected to the common wire 102 via the first switch 51. When the first switch 51 is in the on-state, a current from the current source 31 is supplied to the external capacitor C1 via the common wire 102 and the common terminal 101.

### Reference Voltage Output Unit 32

The reference voltage output unit 32 has a standard voltage source 34 and a voltage divider 35. The standard voltage source 34 outputs a standard voltage VREF to the voltage divider 35. The voltage divider 35 has a first voltage dividing resistor 351, a second voltage dividing resistor 352, a third voltage dividing resistor 353, a fourth voltage dividing resistor 354, and a fifth voltage dividing resistor 355 connected in series in the stated order. In the voltage divider 35, a first end of the first voltage dividing resistor 351 is connected to the standard voltage source 34, and a second end of the fifth voltage dividing resistor 355 is connected to ground.

In the voltage divider 35, the first end of the first voltage dividing resistor 351 and a wire connected to the standard voltage source 34 are connected to each other at a first connection point P1. In addition, the first voltage dividing resistor 351 and the second voltage dividing resistor 352 are connected to each other at a second connection point P2, the second voltage dividing resistor 352 and the third voltage dividing resistor 353 are connected to each other at a third connection point P3, the third voltage dividing resistor 353 and the fourth voltage dividing resistor 354 are connected to each other at a fourth connection point P4, and the fourth voltage dividing resistor 354 and the fifth voltage dividing resistor 355 are connected to each other at a fifth connection point P5.

In the voltage divider 35, the standard voltage VREF is divided by the first voltage dividing resistor 351 through the fifth voltage dividing resistor 355 to generate a first reference voltage Vr1 through a fifth reference voltage Vr5, respectively, that are different voltages. In the voltage divider 35, the voltage at the first connection point P1 is the first reference voltage Vr1. Similarly, the voltage at the second connection point P2 is the second reference voltage Vr2, the voltage at the third connection point P3 is the third reference voltage Vr3, the voltage at the fourth connection point P4 is the fourth reference voltage Vr4, and the voltage at the fifth connection point P5 is the fifth reference voltage Vr5. The first reference voltage Vr1 through the fifth reference voltage Vr5 are generated by the voltage divider 35 such that the first reference voltage Vr1>the second reference voltage Vr2>the third reference voltage Vr3>the fourth reference voltage Vr4>the fifth reference voltage Vr5.

The first connection point P1 through the fifth connection point P5 in the voltage divider 35 are respectively connected to a first comparator 331 through a fifth comparator 335 of the comparing unit 33 to be described later. With this, the first reference voltage Vr1 through the fifth reference voltage Vr5 are supplied to respective inverting input terminals of the first comparator 331 through the fifth comparator 335.

### Current Source 31

As illustrated in FIG. 1, the current source 31 is connected to the common wire 102 via the first switch 51. The current source 31 is supplied with the input voltage VIN and is configured to be driven by the input voltage VIN and to output a current that has a designated current value.

### Comparing Unit 33

The first reference voltage Vr1 through the fifth reference voltage Vr5, which are generated by the voltage divider 35 of the reference voltage output unit 32, and a selection voltage VSL corresponding to the amount of charge in the external capacitor C1 are inputted to the comparing unit 33. Then, the comparing unit 33 compares the selection voltage VSL with each of the first reference voltage Vr1 through the fifth reference voltage Vr5, and outputs the comparison results as a first selection signal Sct1 through a fifth selection signal Sct5. The first selection signal Sct1 through the fifth selection signal Sct5 are outputted to the control unit 4.

The comparing unit 33 has the first comparator 331, the second comparator 332, the third comparator 333, the fourth comparator 334, and the fifth comparator 335. The first comparator 331 through the fifth comparator 335 are comparators that all have the same configuration. The selection voltage VSL is inputted to non-inverting input terminals of the first comparator 331 through the fifth comparator 335. The first reference voltage Vr1 through the fifth reference voltage Vr5 are inputted to the respective inverting input terminals of the first comparator 331 through the fifth comparator 335.

An output from each of the first comparator 331 through the fifth comparator 335 is at a high level when the selection voltage VSL is greater than a corresponding one of the first reference voltage Vr1 through the fifth reference voltage Vr5, and is at a low level when the selection voltage VSL is smaller than that. For example, the output from the third comparator 333 is at the high level when the selection voltage VSL is greater than the third reference voltage Vr3, and is at the low level when the selection voltage VSL is smaller than that. In addition, when the output from the third reference voltage Vr3 is at the high level, the outputs from the fourth comparator 334 and the fifth comparator 335, to which the fourth reference voltage Vr4 and the fifth reference voltage Vr5 that are smaller than the third reference voltage Vr3 are inputted, are also at the high level. Note that, in the present embodiment, the first selection signal Sct1 through the fifth selection signal Sct5 are outputted to the control unit 4.

### Control Unit 4

The control unit 4 detects the first selection signal Sct1 through the fifth selection signal Sct5. Then, according to the first selection signal Sct1 through the fifth selection signal Sct5, the control unit 4 selects a predetermined function from among a plurality of functions and outputs, to the internal circuit 2, a control signal Scr that is designated to drive the selected function. The plurality of functions can be those involved in operation of a configuration in which the semiconductor device 100 is used (for example, a switching power supply device or a composite power supply device that are described later). In addition, the plurality of functions may have a configuration for selecting a function for outputting a signal that is to be outputted to the outside. As the plurality of functions, it is possible to employ functions that can be performed in the circuit inside the semiconductor device 100.

In addition, the control unit 4 has a configuration for outputting a first switch drive signal S_sw1, a second switch drive signal S_sw2, and a third switch drive signal S_sw3 for driving the first switch 51, the second switch 52, and the third switch 53, respectively.

The first switch drive signal S_sw1, the second switch drive signal S_sw2, and the third switch drive signal S_sw3 all can be at a high level or a low level. The first switch 51, the second switch 52, and the third switch 53 enter the on-state when the first switch drive signal S_sw1, the second switch drive signal S_sw2, and the third switch drive signal S_sw3 are at the high level, and enter the off-state when the first switch drive signal S_sw1, the second switch drive signal S_sw2, and the third switch drive signal S_sw3 are at the low level.

### Discharge Unit 6

The semiconductor device 100 has a discharge unit 6 that discharges the external capacitor C1. A discharge instruction signal Sdc is inputted to the discharge unit 6 from the control unit 4. The discharge instruction signal Sdc can be at a high level or a low level. The discharge unit 6 is a circuit that has a configuration for discharging the external capacitor C1 when inputted with a high-level discharge instruction signal Sdc.

The semiconductor device 100 has the configuration as described above. As illustrated in FIG. 2, the semiconductor device 100 has a configuration that enables execution of a discharge operation M1, a selection operation M2, and a supply operation M3. In the semiconductor device 100, the discharge operation M1, the selection operation M2, and the supply operation M3 are controlled by the control unit 4. A description is given below regarding operations performed by the control unit 4 in the discharge operation M1, the selection operation M2, and the supply operation M3.

### Discharge Operation M1

As illustrated in FIG. 2, at a time of the discharge operation M1, the control unit 4 outputs a high-level discharge instruction signal Sdc. As a result, the discharge unit 6 discharges charge that has accumulated in the external capacitor C1. In other words, the discharge operation M1 is an operation for driving the discharge unit 6 to discharge the external capacitor C1. The semiconductor device 100 executes the discharge operation M1, thereby making charge that has been stored in the external capacitor C1 “0.” Note that, as illustrated in FIG. 2, the first switch drive signal S_sw1, the second switch drive signal S_sw2, and the third switch drive signal S_sw3 are at the low level at the time of the discharge operation M1.

### Supply Operation M3

As illustrated in FIG. 2, at the time of the supply operation M3, the control unit 4 outputs the second switch drive signal S_sw2 and the third switch drive signal S_sw3 at the high level. As a result, the second switch 52 and the third switch 53 enter the on-state. In addition, as illustrated in FIG. 2, at a time of the supply operation M3, the first switch drive signal S_sw1 and the discharge instruction signal Sdc are at the low level. At this time, the first switch 51 is in the off-state, and the external capacitor C1 is in a chargeable state. Therefore, the internal power supply unit 1 is connected to the external capacitor C1 via the common wire 102 and is also connected to the internal circuit 2 via the internal circuit connection wire 103. As a result, the external capacitor C1 is charged with the supply voltage VREG from the internal power supply unit 1, and further, the internal circuit 2 is supplied with the supply voltage VREG.

### Selection Operation M2

As illustrated in FIG. 2, at the time of the selection operation M2, the control unit 4 outputs a high-level first switch drive signal S_sw1. As a result, the first switch 51 enters the on-state. In addition, as illustrated in FIG. 2, the second switch drive signal S_sw2, the third switch drive signal S_sw3, and the discharge instruction signal Sdc are at the low level at the time of the selection operation M2. As a result, the second switch 52 and the third switch 53 are turned off, and the external capacitor C1 is connected to the current source 31 of the function selection unit 3.

In the selection operation M2, the external capacitor C1 is charged with the current from the current source 31, and the selection voltage VSL that corresponds to the amount of charge accumulated by charging the external capacitor C1 is inputted to the comparing unit 33 of the function selection unit 3. In the selection operation M2, the selection voltage VSL that corresponds to the amount of charge accumulated in the external capacitor C1 is inputted to the comparing unit 33. The selection voltage VSL is compared with the first reference voltage Vr1 through the fifth reference voltage Vr5 by the first comparator 331 through the fifth comparator 335, respectively. Then, the first selection signal Sct1 through the fifth selection signal Sct5, which correspond to the comparison results, are outputted.

As illustrated in FIG. 2, at the start of the selection operation M2, the amount of charge accumulated in the external capacitor C1 is “0.” At this time, the selection voltage VSL is also “0.” At the start of the selection operation M2, the selection voltage VSL is smaller than each of the first reference voltage Vr1 through the fifth reference voltage Vr5. Therefore, at the start of the selection operation M2, the first selection signal Sct1 through the fifth selection signal Sct5 are all at the low level.

In the selection operation M2, the external capacitor C1 is charged with the current from the current source 31, and the selection voltage VSL also increases in conjunction with the charging of the external capacitor C1. When the selection voltage VSL becomes greater than the fifth reference voltage Vr5, the fifth selection signal Sct5 switches from the low level to the high level. Similarly, when the selection voltage VSL becomes greater than the fourth reference voltage Vr4, the fourth selection signal Sct4 switches from the low level to the high level. In this manner, when the selection voltage VSL becomes greater than each of the reference voltages, the selection signals outputted from the comparators switch from the low level to the high level.

As illustrated in FIG. 2, the selection operation M2 ends after an amount of time T1 has elapsed. In this state, the selection voltage VSL is greater than the third reference voltage Vr3 but less than the second reference voltage Vr2. Accordingly, at the point in time when the selection operation M2 has ended, the first selection signal Sct1 and the second selection signal Sct2 are outputted at the low level from the function selection unit 3, and the third selection signal Sct3, the fourth selection signal Sct4, and the fifth selection signal Sct5 are outputted at the high level from the function selection unit 3.

When the selection operation M2 ends, the control unit 4 outputs, to the internal circuit 2, the control signal Scr that corresponds to the first selection signal Sct1 through the fifth selection signal Sct5 that are at a combination of the high level and the low level when the selection operation M2 ends. The internal circuit 2 is operated by any function that is selected from among the plurality of functions.

The semiconductor device 100 is configured to supply a current to the external capacitor C1 and output a signal that corresponds to the magnitude of the selection voltage VSL, which corresponds to the amount of charge when the external capacitor C1 is charged. The charge amount of the capacitor is proportional to the current and the amount of time over which the current is supplied. In addition, the voltage with respect to the charge amount of the capacitor is inverse proportional to the capacitance of the capacitor.

Accordingly, the semiconductor device 100 can have a configuration in which the value of the current outputted from the current source 31 and the amount of time for the selection operation M2 are made constant, and the output levels of the first selection signal Sct1 through the fifth selection signal Sct5 are adjusted according to the capacitance of the external capacitor C1. By employing such a configuration, it is possible to change the external capacitor C1 and thereby change the first selection signal Sct1 through the fifth selection signal Sct5, in other words, change the function that is selected, without changing the configuration inside the IC. Accordingly, it is possible to improve the versatility of the semiconductor device 100.

In addition, it is possible to reduce the number of external connection terminals in the semiconductor device 100 in comparison to a case of employing a configuration including both an external capacitor to which the internal power supply unit 1 and the internal circuit 2 are connected and an external resistor to which the function selection unit 3 is connected, as in a related-art semiconductor device. Thus, it is possible to simplify the configuration of the semiconductor device 100.

Note that the present embodiment employs the configuration for adjusting the capacitance of the external capacitor C1 such that a combination of the levels of the first selection signal Sct1 through the fifth selection signal Sct5 becomes a given combination, but the configuration is not limited to this. For example, there may be employed a configuration in which the length of time T1 in the selection operation M2 is changed, or a configuration in which the value of the current to be outputted from the current source 31 is changed.

When the selection operation M2 has ended, the control unit 4 switches the first switch drive signal S_sw1 from the high level to the low level. At this time, the selection voltage VSL from external capacitor C1 ceases to be inputted to the function selection unit 3. Accordingly, the first selection signal Sct1 through the fifth selection signal Sct5 from the comparing unit 33 all switch to the low level.

For this reason, in the semiconductor device 100, the control unit 4 may be configured to store information regarding the levels of the first selection signal Sct1 through the fifth selection signal Sct5 received during the selection operation M2. In addition, the comparing unit 33 may be configured to hold the levels of the first selection signal Sct1 through the fifth selection signal Sct5 that have determined during the selection operation M2, and to continue outputting the selection signals. In the case of such a configuration, the comparing unit 33 has a function for resetting the first selection signal Sct1 through the fifth selection signal Sct5 to the low level in response to a signal from the control unit 4. Further, the control unit 4 may control the comparing unit 33 to continue outputting the held first selection signal Sct1 through fifth selection signal Sct5 during the supply operation M3, or may control the comparing unit 33 to reset the first selection signal Sct1 through the fifth selection signal Sct5 after a certain time period has elapsed since the start of the supply operation M3.

### Second Embodiment

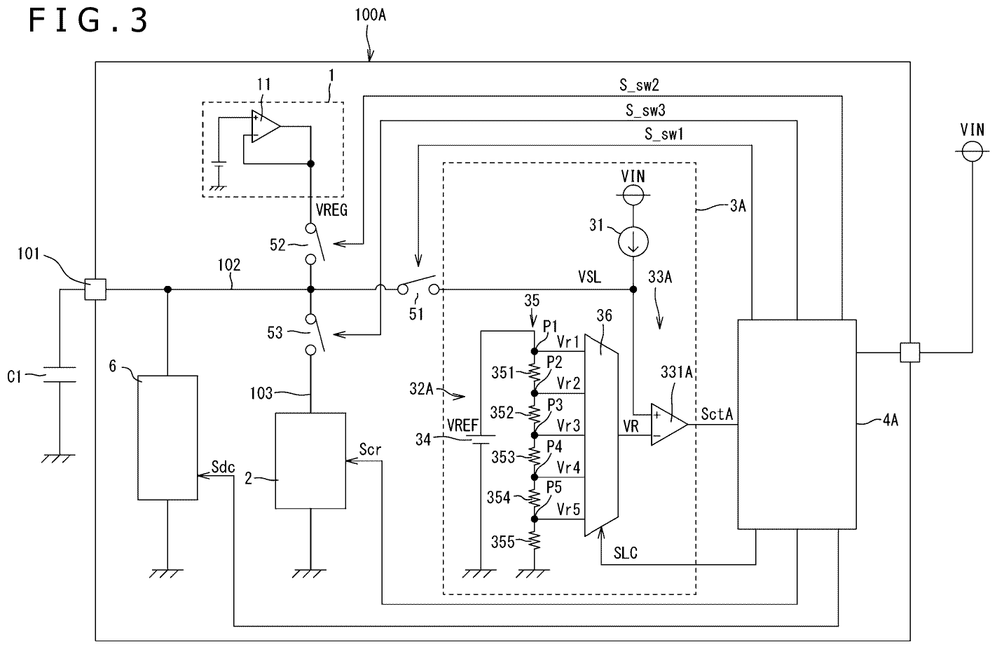

A description is given for a second embodiment of the present disclosure. FIG. 3 is a schematic circuit diagram of a semiconductor device 100A according to the second embodiment. In the semiconductor device 100A illustrated in FIG. 3, a function selection unit 3A and a control unit 4A differ from those of the semiconductor device 100. The same reference symbols are given to constituent elements of the semiconductor device 100A that are substantially the same as those of the semiconductor device 100, and the detailed description thereof is omitted.

As illustrated in FIG. 3, a reference voltage output unit 32A in the semiconductor device 100A has one output terminal and can output any one of the first reference voltage Vr1 through the fifth reference voltage Vr5 as a reference voltage VR. The reference voltage output unit 32A has the standard voltage source 34, the voltage divider 35, and a selector 36. The first reference voltage Vr1 through the fifth reference voltage Vr5 and an adjustment signal SLC are inputted to the selector 36. The selector 36 is configured to, according to the adjustment signal SLC, output any one of the first reference voltage Vr1 through the fifth reference voltage Vr5 as the reference voltage VR. The adjustment signal SLC is outputted from the control unit 4A.

Note that the standard voltage source 34 may be configured to be able to change the voltage value of the output voltage and output a reference voltage that differs according to the adjustment signal SLC. This configuration makes it possible to omit the voltage divider and the selector.

The comparing unit 33A has one comparator 331A. The selection voltage VSL is inputted to a non-inverting input terminal of the comparator 331A. In addition, the reference voltage VR from the selector 36 is inputted to an inverting input terminal of the comparator 331A. Then, the comparator 331A outputs, as a selection signal SctA, a result of comparing the reference voltage VR and the selection voltage VSL.

For example, assume that the selection voltage VSL is greater than the fourth reference voltage Vr4 but less than the third reference voltage Vr3. In this case, the control unit 4A outputs the adjustment signal SLC for setting the reference voltage VR to the fourth reference voltage Vr4, whereby the control unit 4A obtains the selection signal SctA at the high level.

In addition, the control unit 4A outputs the adjustment signal SLC for setting the reference voltage VR to the third reference voltage Vr3, whereby the control unit 4A obtains the selection signal SctA at the low level. In this manner, according to the selection voltage VSL, the adjustment signal SLC for when the selection signal SctA becomes the high level differs. The control unit 4A can select any function from among a plurality of functions on the basis of the adjustment signal SLC that enables the selection signal SctA at the high level to be obtained.

As described above, the selection signal VSL increases over time. Accordingly, upon receiving the selection signal SctA at the high level, the control unit 4A may output an adjustment signal SLC for switching a next greater reference voltage to the reference voltage VR.

With the semiconductor device 100A having such a configuration, it is possible to reduce the number of comparators. This can reduce the size of the semiconductor device 100A and also reduce power consumption.

### Usage

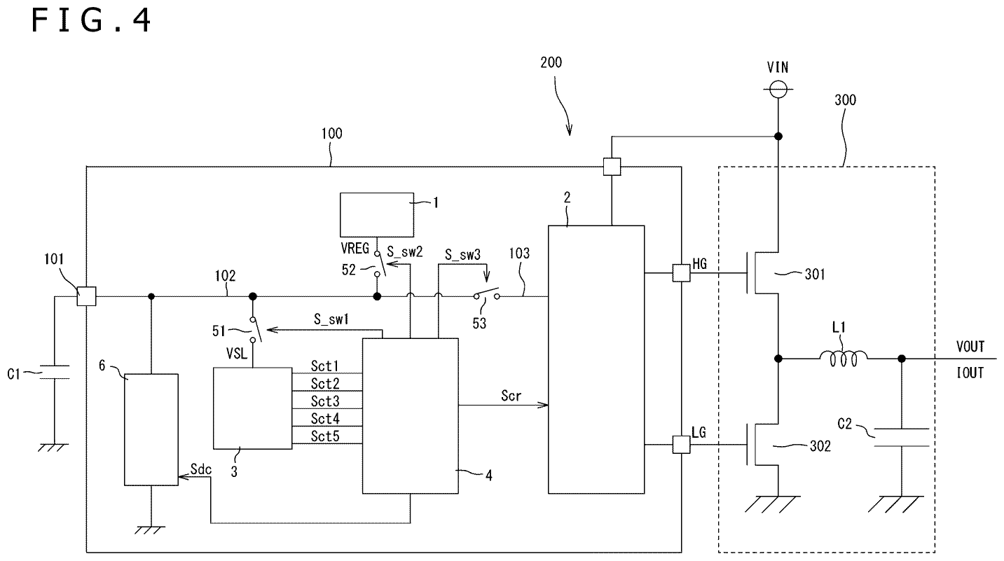

FIG. 4 is a schematic circuit diagram that illustrates an exemplary configuration of a switching power supply device 200 that uses the semiconductor device 100. The switching power supply device 200 is used as a voltage source for supplying a power supply voltage in a vehicle such as an automobile, a conveyance apparatus, an industrial robot, or other machines.

As illustrated in FIG. 4, the switching power supply device 200 has the semiconductor device 100, the external capacitor C1, a switching output stage 300, an inductor L1, and a smoothing capacitor C2.

In the switching power supply device 200, the switching output stage 300 has a high-side switching element 301 and a low-side switching element 302 which are disposed between the input voltage VIN and a ground voltage. The high-side switching element 301 and the low-side switching element 302 are both N-channel MOS transistors. However, they are not limited to this configuration, and the high-side switching element may be a P-channel MOS transistor, and the low-side switching element may be an N-channel MOS transistor.

The source of the high-side switching element 301 is connected to the drain of the low-side switching element 302. The drain of the high-side switching element 301 is connected to the input voltage VIN, and the source of the low-side switching element 302 is connected to the ground voltage. A high-side gate signal HG and a low-side gate signal LG are inputted to the respective gates of the high-side switching element 301 and the low-side switching element 302 from the control unit 4.

The high-side switching element 301 and the low-side switching element 302 are operated to be turned on or off in a complementary manner, using the high-side gate signal HG and the low-side gate signal LG. Note that a complementary manner indicates a state in which, when one switching element is on, the other is turned off. Here, also assumed is a case in which both are turned off at the same time, but not a case in which both are turned on at the same time.

The switching power supply device 200 causes the high-side switching element 301 and the low-side switching element 302 to operate in a complementary manner, to thereby output an output voltage VOUT. The output voltage VOUT is determined according to the on-duty ratio of the high-side switching element 301.

The internal circuit 2 of the semiconductor device 100 used in the switching power supply device 200 has a driver circuit for driving the switching output stage 300 and a duty determination circuit for determining the on-duty ratio of the high-side switching element 301. In the semiconductor device 100, examples of the plurality of functions set in the internal circuit 2 include a plurality of on-duty ratios.

In other words, the control unit 4 transmits the control signal Scr to the internal circuit 2 in order to drive the switching output stage 300 at a designated on-duty ratio according to the first selection signal Sct1 through the fifth selection signal Sct5 from the function selection unit 3. In other words, the semiconductor device 100 causes the switching output stage 300 to operate at an on-duty ratio that corresponds to the first selection signal Sct1 through the fifth selection signal Sct5. With this, the switching power supply device 200 changes the capacitance of the external capacitor C1 connected to the semiconductor device 100, to thereby output the output voltage VOUT that is a voltage required in a vehicle, for example. In other words, it is possible to improve the versatility of the switching power supply device 200.

Note that, while the switching power supply device 200 illustrated in FIG. 4 is a step-down converter, the same applies to a step-up converter. In addition, functions of the switching power supply device 200 are on-duty ratios for the high-side switching element 301, but they are not limited thereto.

In addition, it is also possible to employ a linear IC in which a low drop-out (LDO) regulator circuit is disposed, instead of the switching output stage 300. In such a configuration, an output voltage VOUT from the LDO regulator circuit may be adjustable and be adjusted in the internal circuit 2. Even with such a configuration, the external capacitor C1 having an appropriate capacitance is selected, whereby a desired output voltage VOUT can be outputted.

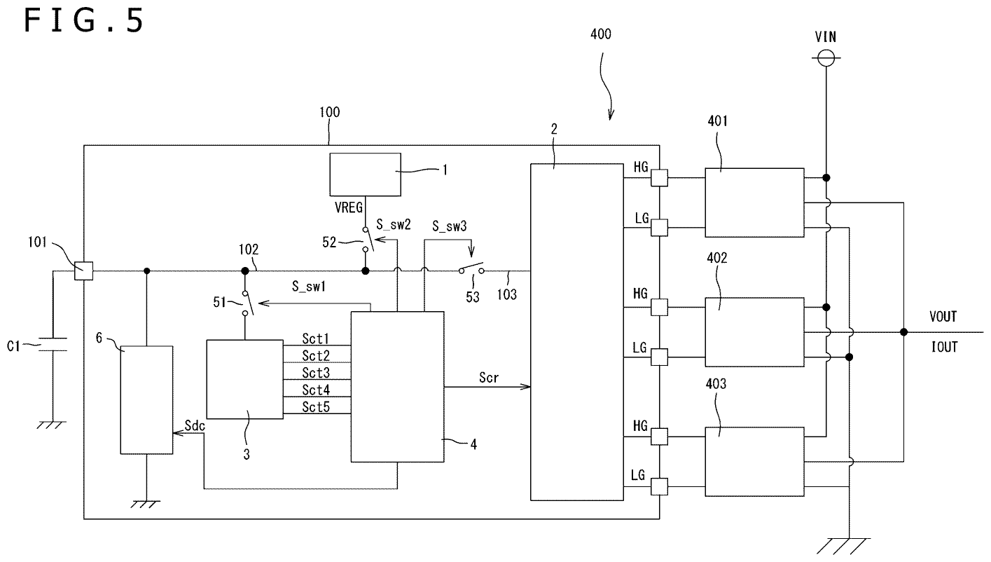

FIG. 5 is a schematic circuit diagram that illustrates an exemplary configuration of a composite power supply device 400 that uses the semiconductor device 100. As illustrated in FIG. 5, the composite power supply device 400 has the semiconductor device 100 and three output stages 401, 402, and 403.

In the composite power supply device 400, the first output stage 401, the second output stage 402, and the third output stage 403 are each a switching regulator that uses a direct current to direct current (DC/DC) converter. In the composite power supply device 400, it is possible to adjust an output current TOUT according to the number of output stages that operate (referred to as being set to active).

In the composite power supply device 400, as a plurality of functions that the internal circuit 2 can execute, it is possible to increase the number of output stages to be set to active and the on-duty value for the high-side switching element. In other words, the control unit 4 outputs, to the internal circuit 2, the control signal Scr that corresponds to the first selection signal Sct1 through the fifth selection signal Sct5. In response to the control signal Scr, the internal circuit 2 determines output stages to be set to active according to the number of output stages to be set to active, and outputs, to the output stages to be set to active, a high-side gate signal HG and a low-side gate signal LG for causing high-side switching elements to operate at a designated on-duty value.

In such a manner, it is possible to adjust the output current IOUT from the composite power supply device 400 according to the capacitance of the external capacitor C1 for the semiconductor device 100. Therefore, it is possible to improve the versatility of the composite power supply device 400.

In addition, in the composite power supply device 400, the output stages 401, 402, and 403 are switching regulators, but they are not limited thereto, and at least one of them may be a linear regulator.

### Other

The abovementioned embodiments are examples in all aspects and should not be considered as restrictive. The technical scope of the present disclosure is indicated by not the description of the abovementioned embodiments but the scope of the claims, and should be understood to include all modifications within meaning and scope equivalent to those of the claims.

### Supplementary Note

A semiconductor device (100, 100A) described above may have a configuration (first configuration) including a common terminal (101) connected to an external capacitor (C1) outside of the semiconductor device (100, 100A), a function selection unit (3, 3A) configured to execute a selection operation (M2) for outputting a selection signal (Sct1 through Sct5) for selecting a designated function according to an amount of charge accumulated in the external capacitor (C1), and an internal power supply unit (1) configured to supply a voltage to an internal circuit (2) provided inside the semiconductor device (100, 100A), in which the external capacitor (C1) is electrically connected to the function selection unit (3, 3A) when the selection operation (M2) is performed, and the external capacitor (C1) is electrically connected to the internal power supply unit (1) and the internal circuit (2) when a supply operation (M3) for supplying a supply voltage (VREG) from the internal power supply unit (1) to the internal circuit (2) is performed.

The semiconductor device (100, 100A) according to the first configuration may have a configuration (second configuration) in which the function selection unit (3, 3A) charges the external capacitor (C1) for a predetermined amount of time (T1) in the selection operation (M2).

The semiconductor device (100, 100A) according to the first or second configuration may have a configuration (third configuration) in which the supply operation (M3) is performed after the selection operation (M2) is performed.

The semiconductor device (100, 100A) according to any one of the first through third configurations may have a configuration (fourth configuration) in which a discharge operation (M1) for discharging the external capacitor (C1) is executed before the selection operation (M2) is performed.

The semiconductor device (100, 100A) according to any one of the first through fourth configurations may have a configuration (fifth configuration) in which the function selection unit (3, 3A) holds the selection signal (Sct1 through Sct5) and continues outputting the selection signal (Sct1 through Sct5) after the selection operation (M2) has ended.

The semiconductor device (100, 100A) according to any one of the first through fifth configurations may have a configuration (sixth configuration) in which the function selection unit (3, 3A) has a reference voltage output unit (32, 32A) configured to output reference voltages (Vr1 through Vr5) that are different voltages, and a comparing unit (33, 33A) configured to compare a selection voltage (VSL) that corresponds to the charge accumulated in the external capacitor (C1) with the respective reference voltages (Vr1 through Vr5), and output a result of the comparison.

The semiconductor device (100) according to the sixth configuration may have a configuration (seventh configuration) in which the reference voltage output unit (32) has a standard voltage source (34) configured to output a given standard voltage (VREF) and a voltage divider (35) configured to divide the standard voltage (VREF) and supply a plurality of the reference voltages (Vr1 through Vr5) that are different voltages, and the comparing unit (33) has a plurality of comparators (331 through 335) configured to compare the selection voltage (VSL) with the respective reference voltages (Vr1 through Vr5) and output a result of the comparison.

The semiconductor device (100A) according to the sixth configuration may have a configuration (eighth configuration) in which the reference voltage output unit (32A) supplies the reference voltages (Vr1 through Vr5) that are different voltages to the comparing unit (33A).

The semiconductor device (100, 100A) according to any one of the first through eighth configurations may have a configuration (ninth configuration) including a common wire (102) connected to the common terminal (101), an internal circuit connection wire (103) connected to the internal circuit (2), a first switch (51) disposed between the common wire (102) and the function selection unit (3, 3A), a second switch (52) disposed between the common wire (102) and the internal power supply unit (1), a third switch (53) disposed between the common wire (102) and the internal circuit connection wire (103), and a control unit (4), in which the control unit (4) performs control to bring the first switch (51) into a conductive state and bring the second switch (52) and the third switch (53) into a non-conductive state when the selection operation (M2) is performed, and bring the first switch (51) into a non-conductive state and bring the second switch (52) and the third switch (53) into a conductive state when the supply operation (M3) is performed.

A switching power supply device (200) described above may have a configuration (tenth configuration) including the semiconductor device (100, 100A) according to any one of the first through ninth configurations and a switching output stage (300) configured to be driven by the semiconductor device (100, 100A).

A composite power supply device (400) described above may have a configuration (eleventh configuration) including the semiconductor device (100, 100A) according to any one of the first through ninth configurations and a plurality of output stages (401, 402, 403) configured to be driven by the semiconductor device (100, 100A), in which at least one of the plurality of output stages (401, 402, 403) is operated by the semiconductor device (100, 100A).

A linear IC described above may have a configuration (twelfth configuration) that uses the semiconductor device (100, 100A) according to any one of the first through ninth configurations.

What is claimed is:

1. A semiconductor device comprising:
a common terminal connected to an external capacitor outside of the semiconductor device;
a function selection unit configured to execute a selection operation for outputting a selection signal for selecting a designated function according to an amount of charge accumulated in the external capacitor; and
an internal power supply unit configured to supply a voltage to an internal circuit provided inside the semiconductor device, wherein
the external capacitor is electrically connected to the function selection unit when the selection operation is performed, and the external capacitor is electrically connected to the internal power supply unit and the internal circuit when a supply operation for supplying a supply voltage from the internal power supply unit to the internal circuit is performed.

2. The semiconductor device according to claim 1, wherein
the function selection unit charges the external capacitor for a predetermined amount of time in the selection operation.

3. The semiconductor device according to claim 1, wherein
the supply operation is performed after the selection operation is performed.

4. The semiconductor device according to claim 1, wherein
a discharge operation for discharging the external capacitor is executed before the selection operation is performed.

5. The semiconductor device according to claim 1, wherein
the function selection unit holds the selection signal and continues outputting the selection signal after the selection operation has ended.

6. The semiconductor device according to claim 1, wherein
the function selection unit has
a reference voltage output unit configured to output reference voltages that are different voltages, and
a comparing unit configured to compare a selection voltage that corresponds to the charge accumulated in the external capacitor with the respective reference voltages, and output a result of the comparison.

7. The semiconductor device according to claim 6, wherein
the reference voltage output unit has
a standard voltage source configured to output a given standard voltage, and
a voltage divider configured to divide the standard voltage and supply a plurality of the reference voltages that are different voltages, and
the comparing unit has a plurality of comparators configured to compare the selection voltage with the respective reference voltages and output a result of the comparison.

8. The semiconductor device according to claim 6, wherein
the reference voltage output unit supplies the reference voltages that are different voltages to the comparing unit.

9. The semiconductor device according to claim 1, further comprising:
a common wire connected to the common terminal;
an internal circuit connection wire connected to the internal circuit;
a first switch disposed between the common wire and the function selection unit;
a second switch disposed between the common wire and the internal power supply unit;
a third switch disposed between the common wire and the internal circuit connection wire; and
a control unit, wherein
the control unit performs control to bring the first switch into a conductive state and bring the second switch and the third switch into a non-conductive state when the selection operation is performed, and bring the first switch into a non-conductive state and bring the second switch and the third switch into a conductive state when the supply operation is performed.

10. A switching power supply device comprising:
the semiconductor device according to claim 1; and
a switching output stage configured to be driven by the semiconductor device.

11. A composite power supply device comprising:
the semiconductor device according to claim 1; and
a plurality of output stages configured to be driven by the semiconductor device, wherein
at least one of the plurality of output stages is operated by the semiconductor device.

12. A linear integrated circuit that uses the semiconductor device according to claim 1.
